(19) United States
(12) Patent Application Publication
(10) Pub. No.: US 2022/0191094 A1
(43) Pub. Date: Jun. 16, 2022

(54) Handling of Antenna line Devices in High Layer Split Architecture

(71) Applicant: Nokia Solutions and Networks Oy, Espoo (FI)

(72) Inventors: Pawel KOCH, Wroclaw (PL); Marek MICHALAK, Wroclaw (PL)

(21) Appl. No.: 17/593,058

(22) PCT Filed: Mar. 8, 2019
(86) PCT No.: PCT/EP2019/055805

§ 371 Date: Sep. 8, 2021

(51) Int. Cl. H04L 41/0813; H04L 41/12

(52) U.S. Cl. CPC H04L 41/0813; H04W 88/085; H04L 41/12

(57) ABSTRACT

A centralized unit of a communication network adopting a high layer split architecture acquires an abstractive model of a plurality of antenna line devices from a distributed unit of the communication network. The centralized unit operates the plurality of antenna line devices by communicating with the distributed unit by using the abstractive model. The distributed unit can perform elementary control of the plurality of antenna line devices based on the communication with the centralized unit.

### TECHNICAL FIELD

At least some embodiments relate to handling of antenna line devices (ALDs) in high layer split (HLS) architecture.

### BACKGROUND

High layer split (HLS) is an option of functional splits between central and distributed units in new radio (NR).

Communication with Antenna Line Devices (ALDs) conforms to HDLC and AISG 2.0/3GPP TS 25.46x.

For HLS 2-box model raw communication between RU as HDLC primary device and ALD as HDLC secondary device is invisible from gNB-CU-gNB-DU interface perspective.

### LIST OF ABBREVIATIONS

3GPP Third Generation Partnership Project

5G Fifth Generation

ALD Antenna Line Device

AISG Antenna Interface Standards Group

gNB 5G NodeB

HDLC High-Level Data Link Control

HLS High Layer Split

gNB-CU gNB-Centralized Unit

gNB-DU gNB-Distributed Unit

LNA Low Noise Amplifier

LLS Lower Layer Split

MU Middle Unit

NETCONF Network Configuration Protocol

NMS Network Management System

NR New Radio

RAE eAntenna

RET Remote Electrical Tilt

RPC Remote Procedure Call

RU Radio Unit

UID Unique Identifier

UINT8 8-bit unsigned integer arrays

YANG Yet Another Next Generation

### SUMMARY

At least some embodiments aim at providing optimized and effective Antenna Line Device (ALD) control for HLS architecture.

At least some embodiments allow for multivendor implementations.

Additionally, at least some embodiments solve a problem of massive traffic, number of connections towards a managing entity, and hard timing for messages.

According to at least some embodiments, required processing power is also divided between controlling entity (e.g. gNB-CU/NMS) and executing entity (e.g. gNB-DU/MU). Limitation for number of ALDs under control caused by HDLC address of UINT8 is also solved according to at least some embodiments.

At least some embodiments provide for optimized control for Antenna Line Devices (ALDs) in HLS environment, allow for multivendor applications, solve bottlenecks caused by HDLC communication, and bypass constraint caused by HDLC address according to UINT8.

At least some embodiments are AISG 3.0 ready.

At least some embodiments reuse LLS specification as much as possible, especially in HLS 3-Box model.

According to an example embodiment, a centralized unit is provided as specified in the appended claims.

According to another example embodiment, a distributed unit is provided as specified in the appended claims.

According to further example embodiments, methods and storage media are provided as specified in the appended claims.

In the following, example embodiments will be described with reference to the accompanying drawings.

### BRIEF DESCRIPTION OF THE DRAWINGS

FIG. 1 shows a schematic block diagram illustrating an HLS architecture according to at least some embodiments.

FIG. 2 shows flowcharts illustrating procedures performed by a centralized unit and a distributed unit according to at least some embodiments.

FIG. 3 shows a diagram illustrating a high level model for ALDs according to at least some embodiments.

FIG. 4 shows a schematic block diagram illustrating a configuration of control units in which examples of embodiments are implementable.

### DESCRIPTION OF THE EMBODIMENTS

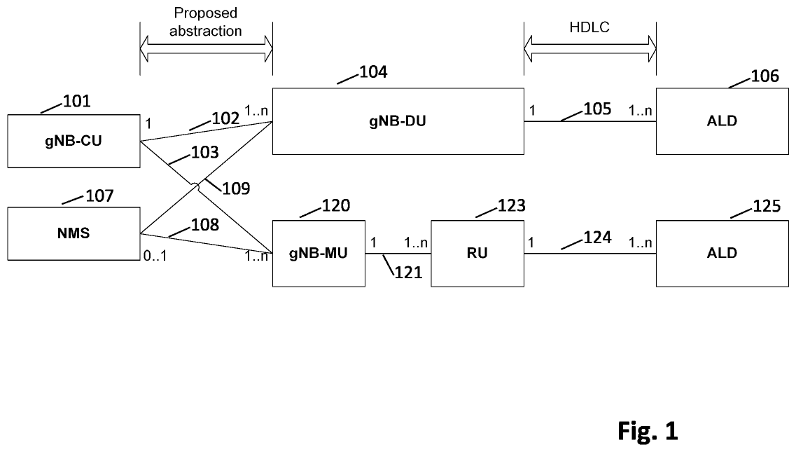

FIG. 1 shows a schematic block diagram illustrating an HLS architecture according to at least some embodiments.

The HLS architecture illustrated in FIG. 1 comprises a gNB-CU 101 which is an example of a centralized unit. The gNB-CU 101 is operable to communicate with a gNB-DU 104 via an interface 102. It is noted that the gNB-CU 101 is operable to communicate with a plurality of gNB-DUs 104 (e.g. 1 . . . n gNB-DUs as indicated in FIG. 1) via 1 . . . n interfaces 102. The gNB-DU 104 is an example of a distributed unit.

For example, the gNB-CU 101 further is operable to communicate with a gNB-MU 120 via an interface 103. It is noted that the gNB-CU 101 is operable to communicate with a plurality of gNB-MUs 120 (e.g. 1 . . . n gNB-MUs as indicated in FIG. 1) via 1 . . . n interfaces 103.

The gNB-DU 104 is operable to communicate with an ALD 106 via an interface 105. It is noted that the gNB-DU 104 is operable to communicate with a plurality of ALDs 106 (e.g. 1 . . . n ALDs as indicated in FIG. 1) via 1 . . . n interfaces 105.

For example, the HLS architecture illustrated in FIG. 1 further comprises an NMS 107 which is an example of a centralized unit. The NMS 107 is operable to communicate with the gNB-MU 120 via an interface 108. It is noted that the NMS 107 is operable to communicate with a plurality of gNB-MUs 120 (e.g. 1 . . . n gNB-MUs as indicated in FIG. 1) via 1 . . . n interfaces 108. The gNB-MU 120 is an example of a distributed unit.

For example, the NMS 107 further is operable to communicate with the gNB-DU 104 via an interface 109. It is noted that the NMS 107 is operable to communicate with a plurality of gNB-DUs (e.g. 1 . . . n gNB-DUs as indicated in FIG. 1) via 1 . . . n interfaces 109.

The gNB-MU 120 is operable to communicate with an ALD 125 via an RU 123. For example, the gNB-MU 120 is operable to communicate with a plurality of RUs 123 (e.g. 1 . . . n RUs as indicated in FIG. 1) via 1 . . . n interfaces 121. The RU 123 is operable to communicate with 1 . . . n ALDs 125 via 1 . . . n interface 124.

In a system as e.g. shown in FIG. 1, controller's role over gNB-DU 104/gNB-MU 120 can be taken by gNB-CU 101 or NMS 107. Number of ALDs 106, 125 an operator can connect through gNB-DU 104/gNB-MU 120 is significantly big. Communication with ALDs 106, 125 may be time sensitive. To not to overload a controlling entity (e.g. neither gNB-CU 101 nor NMS 107) with elementary ALD handling procedures and not to put timing requirements on that entity, according to at least some embodiments elementary ALD control is moved to the level of gNB-DU 104/gNB-MU 120.

According to at least some embodiments, ALDs 106, 125 are exposed by gNB-MU 120/gNB-DU 104 e.g. to gNB-CU 101 in form or through Netconf/YANG modules or any other convenient abstractive model with a set of ALD-proprietary parameters, operation calls and appropriate notifications to propagate information about ALD state and parameters change to gNB-CU 101.

It is noted that YANG is a data modeling language for the definition of data sent over network configuration protocol.

It is further noted that YANG is merely an example here, and the abstractive model is in no way limited thereto. Also Netconf RPC is just an example of a remote procedure call, and any other media for call handling can be used.

Elementary control over ALDs 106, 125 belongs to gNB-DU 104/gNB-MU 120. gNB-CU 101 or NMS 107 requests for changes in ALD parameters or for operations to be performed by ALD 106, 125 through interactions with the abstractive model exposed by gNB-DU 104/gNB-MU 120 (the abstractive model is referred to as “Proposed abstraction” in FIG. 1). Elementary ALD control is understood as set of elementary procedures and functions related to HDLC and AISG2.0/3.0 protocol layer termination: HDLC scan, device detection, HDLC address assignment, polling, communication with ALDs with respect to timing constraints, alarm reporting, ALD configuration and so on. ALDs 106, 125 are considered as secondary devices, whilst gNB-DU 104 and gNB-MU 120 are considered as primary devices.

In this concept, gNB-DU 104 or gNB-MU 120 provides the controlling entity (gNB-CU 101 or NMS 107) with abstraction representing discovered ALDs.

For example, an elementary procedure is a unit of interaction between the primary device and the secondary device.

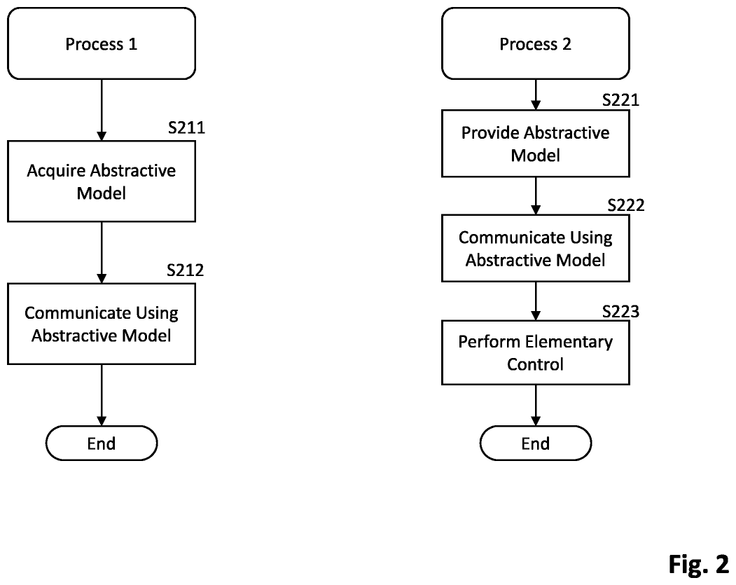

Now reference is made to FIG. 2 illustrating procedures performed by a centralized unit and a distributed unit according to at least some embodiments.

According to an example embodiment, process 1 shown in FIG. 2 is executed by a centralized unit (e.g. gNB-CU 101, NMS 107) that is usable in a communication network which adopts a high layer split architecture. For example, the centralized unit comprises and/or uses at least one processor and at least one memory including computer program code, the at least one memory and the computer program code configured to, with the at least one processor, cause the centralized unit to perform process 1. According to an implementation example, the at least one processor comprises at least one physical or virtual processor, e.g. processing thread.

In step S211, an abstractive model of a plurality of antenna line devices is acquired from a distributed unit (e.g. gNB-DU 104, gNB-MU 120) of the communication network, wherein the distributed unit performs elementary control of the plurality of antenna line devices.

In step S212, the plurality of antenna line devices is operated by communicating with the distributed unit by using the abstractive model.

After step S212, process 1 ends.

According to an implementation example, operating the antenna line devices in step S212 comprises at least one of requesting for changes in parameters of at least one of the plurality of antenna line devices and requesting operations to be performed by at least one of the plurality of antenna line devices.

According to an example embodiment, process 2 shown in FIG. 2 is executed by a distributed unit (e.g. gNB-DU 104, gNB-MU 120) for use in a communication network which adopts a high layer split architecture. For example, the distributed unit comprises at least one processor and at least one memory including computer program code, the at least one memory and the computer program code configured to, with the at least one processor, cause the distributed unit to perform process 2. According to an implementation example, the at least one processor comprises at least one physical or virtual processor, e.g. processing thread.

In step S221, an abstractive model of a plurality of antenna line devices (e.g. ALDs 106, 125) is provided to a centralized unit (e.g. gNB-CU 101, NMS 107) of the communication network.

In step S222, communication with the centralized unit is performed by using the abstractive model regarding operation of the plurality of antenna line devices.

In step S223, elementary control of the plurality of antenna line devices is performed, for example based on the communication with the centralized unit in step S222.

After step S223, process 2 ends.

According to an implementation example, the elementary control comprises a set of elementary procedures and functions related to protocol layer termination according to at least one of high-level data link control, HDLC, and antenna interface standards group, AISG.

According to an implementation example, performing of the elementary control in step S223 comprises at least one of the following:

detecting antenna line devices of the plurality of antenna line devices, which comply with high-level data link control device detection;

scanning connected antenna line devices of the plurality of antenna line devices, which comply with high-level data link control;

assigning high-level data link control addresses to connected antenna line devices which comply with high-level data link control;

polling towards antenna line devices of the plurality of antenna line devices, which have been assigned high-level data link control addresses; and

communicating with antenna line devices of the plurality of antenna line devices, which have been assigned high-level data link control addresses, with respect to at least one of timing constraints, alarm reporting and configuration of the antenna line devices.

According to an implementation example, the abstractive model provided in step S221 and acquired in step S211 comprises at least one of the following: modules according to network configuration protocols, modules according to yet another next generation protocol (YANG), and a model comprising at least one of a set of proprietary parameters of each of the plurality of antenna line devices, operation calls and notifications to propagate information about at least one of the plurality of antenna line devices to the centralized unit.

Now messaging performed to take antenna line devices (e.g. ALDs 106, 125) into operation will be described by referring again to FIG. 1.

According to an implementation example, before ALDs 106, 125 can be taken into operation by gNB-DU 104 and gNB-MU 120, gNB-CU 101 and NMS 107 use Netconf RPCs to enable gNB-DU 104 and MU 120 to carry out HDLC bus scan and HDLC addresses assignment, as indicated by “HDLC” in FIG. 1. It is noted that any other action trigger that complies with used protocol stack can be used for enabling gNB-DU 104 and gNB-MU 120 to carry out HDLC bus scan and HDLC addresses assignment.

For example, the following operations are implemented in order to get ALDs into service:

| Operation | Parameters | Response |
|---|---|---|
| Enable HDLC | port [port_id] | ACK |
| | active [boolean] | NACK (reason) |

Allowed NACK Reasons:

| NACK reason | Meaning |
|---|---|
| Invalid | Operation cannot be performed against desired port |
| operation | (e.g. the port is not equipped with HDLC modem) |

In other words, according to an example embodiment, the centralized unit (e.g. gNB-CU 101, NMS 107) performs an operation to enable high-level data link control (HDLC) between the distributed unit (e.g. gNB-DU 104, gNB-MU 120) and the plurality of antenna line devices (e.g. ALDs 106, 125).

According to an implementation example, the centralized unit transmits an action trigger to the plurality of antenna line devices.

Once HDLC is enabled between gNB-DU 104/gNB-MU 120 and ALDs 106, 125, gNB-DU 104 and gNB-MU 120 starts HDLC bus scan to detect connected HDLC devices. Detected HDLC devices (e.g. ALDs 106, 125) are reported by the gNB-DU 104 and gNB-MU 120 in form of inventory notification(s), for example, assuming that gNB-CU 101 and NMS 107 are subscribed to inventory information. Further, detected and lost HDLC devices are reflected in form of inventory, for example. This applies also to HDLC devices having no HDLC address assigned as per gNB-CU 101/NMS 107 request.

In other words, according to an example embodiment, the distributed unit (e.g. gNB-DU 104, gNB-MU 120) scans connected antenna line devices of the plurality of antenna line devices, which comply with high-level data link control.

Further, according to an example embodiment, the distributed unit (e.g. gNB-DU 104, gNB-MU 120) detects antenna line devices of the plurality of antenna line devices, which comply with high-level data link control device detection.

Further, according to an example embodiment, the distributed unit (e.g. gNB-DU 104, gNB-MU 120) provides the centralized unit (e.g. gNB-CU 101, NMS 107) with notifications about connected antenna line devices of the plurality of antenna line devices, which comply with high-level data link control.

According to an example embodiment, the centralized unit (e.g. gNB-CU 101, NMS 107) acquires the notifications about the connected antenna line devices of the plurality of antenna line devices, which comply with high-level data link control, and requests the distributed unit to assign high-level data link control addresses to the connected antenna line devices which comply with high-level data link control. For example, a request to assign a high-level data link control address of a connected antenna line device comprise a unique identifier (UID) which uniquely identifies the connected antenna line device.

According to an example embodiment, the distributed unit (e.g. gNB-DU 104, gNB-MU 120) obtains the request to assign high-level data link control addresses from the centralized unit (e.g. gNB-CU 101, NMS 107) and assigns high-level data link control addresses to the connected antenna line devices which comply with high-level data link control. For example, a high-level data link control (HDLC) address is assigned to a connected antenna line device indicated in the request by a unique identifier (UID) which uniquely identifies the connected antenna line device. According to an example implementation, the distributed unit (e.g. gNB-DU 104, gNB-MU 120) stores a mapping between UID and HDLC address.

| Operation | Parameters | Response |
|---|---|---|
| Assign HDLC | UID [19 octets] | ACK |
| address | | NACK (reason) |

According to at least some embodiments, the centralized unit does not know HDLC addresses, but only identifiers (e.g. UIDs) of ALDs which are unique per DU/MU. CU triggers RPCs per objects representing ALDs at DU/MU level. Pair of CU/MU and object representing particular ALD is then unique within whole communication network system. The UID parameter in the above “Assign HDLC address” operation is an ID of an ALD that CU requests to have an HDLC address assigned by DU/MU.

It is noted that AISG 3.0 will not allow for ASCII character 0x20.

According to an implementation example, UID is formed of two parts: for example, part 1 is Vendor Code (2 octets) and part 2 is Serial Number (AISG 2.0) or other “identifying alphanumeric designation for each product complying with this specification, assigned by the product manufacturer and having a maximum length of 17 octets” (AISG 3.0). In case second part is shorter than 17 octets, then UID is formed as Vendor Code plus padding to 17 octets plus second part. For padding octets, containing 0x00 must be used. Allowed range for octets in UID spans between ASCII 0x20 and 0x7E (plus ASCII 0x00 in case padding is needed).

According to an example embodiment, after successful HDLC address assignment, gNB-DU autonomously starts polling towards such a device. According to an implementation example, in case polling towards ALD is lost, its state indicates “lost” in inventory data.

In other words, according to an example embodiment, the distributed unit (e.g. gNB-DU 104, gNB-MU 120) polls towards antenna line devices of the plurality of antenna line devices, which have been assigned high-level data link control addresses.

In the following, ALD operations will be described. According to an implementation example, to trigger ALD-related operation on gNB-DU 104/gNB-MU 120, gNB-CU 101/NMS 107 uses Netconf RPCs.

| Operation | Parameters | Response |
|---|---|---|
| ALD | UID [19 octets] | ACK |
| operation | ALD operation [string] | NACK (reason) |
| | ALD operation parameters | NOTIFICATION: completed |
| | [list: :string] | (Product Code, Serial |
| | | Number, UID, ALD |
| | | operation, status, |
| | | return code) |

Allowed NACK Reasons:

| NACK reason | Meaning |
|---|---|
| Busy | device is busy handling previously issued operation |
| Invalid operation | the operation does not apply to device is has been |
| | issued against |
| Incorrect value | value issued with the operation is out of supported |
| | range |
| Unknown | device cannot perform requested operation due to |
| execution error | unknown issue |
| Object not found | device for which operation is issued has not been |
| | found |

It is noted that with this approach ALD configurations involving both non-time-consuming and time-consuming operations are handled in the same way. It is allowed that non-time-consuming operations are interleaved with time consuming operations.

ALD Operations:

| ALD operation | Response | Notification |
|---|---|---|
| ret_calibration_request | ACK/NACK | Yes |
| ret_set_angle_request | ACK/NACK | Yes |
| ret_get_angle_request | ACK/NACK | No |
| ret_config_request | ACK/NACK | No |
| set_device_data_request | ACK/NACK | No |
| get_device_data_request | ACK/NACK | Yes |
| lna_set gain_request | ACK/NACK | No |
| lna_set_gain_mode_request | ACK/NACK | No |
| rae_get_configuration_file_request | ACK/NACK | Yes |
| xid_reset_request | ACK/NACK | No |
| (broadcast, unicast) | | |

According to an implementation example, notifications are used for time consuming operations. Non time-consuming operations can deliver their result together with ACK/NACK response.

It is noted that for each supported operation ALD UID should be indicated in order to have the operation executed with the context of desired ALD. In other words, in step S211 in FIG. 2, the high-level data link control addresses are used for operating the plurality of antenna line devices by communicating with the distributed unit by using the abstractive model.

Additional parameters depend on supported operation and conform to 3GPP TS 25.466 document, for example.

Common ALD Parameters:

| Parameter | Type | Expected values |
|---|---|---|
| Availability Status | R | ENUM: not detected, detected, |
| | | addressed, lost, degraded, failed |
| Usage State | R | ENUM: idle, busy |
| Serial Number | R | up to 255 octets (0x21 . . . 0x7E). |
| Hardware Version | R | up to 255 octets (0x21 . . . 0x7E) |
| Vendor Code | R | 2 octets (0x21 . . . 0x7E) |
| Device Type | R | 1 octet |
| Software version | R | string (30) |
| Hardware version | R | string (30) |
| Assigned HDLC address | R | Integer (1 . . . 254) |
| 3GPP Release Version | R | Integer (1 . . . 255) |
| AISG Protocol Version | R | Integer (2 . . . 255) |
| AISG Substance Version | R | Integer (0 . . . 255) |

It is noted that the length of Serial Number should meet the minimum size of HDLC message negotiated between Primary Device and Secondary Device, which, is 74 octets, for example.

RET Specific Parameters:

| Parameter | Type | Expected values |
|---|---|---|
| Min Supported Tilt | R | Float. Value up to vendor. |
| Angle | | |
| Max Supported Tilt | R | Float. Value up to vendor. |
| Angle | | |
| Tilt Angle | RW | between Min Supported Tilt Angle and Max |
| | | Supported Tilt Angle (inclusive) |
| Additional Data | RW | 137 octets (see: TS 25.466 Annex B, Table |
| | | B.1) |
| Is calibrated | R | Boolean |
| Is configured | R | Boolean |

LNA Specific Parameters:

| Parameter | Type | Expected values |
|---|---|---|
| Min Gain | R | Float (value up to vendor) |
| Max Gain | R | Float (value up to vendor) |
| Gain Resolution | R | Float (value up to vendor) |
| Non-linear Values | R | List of floats (values up to vendor) |
| Gain | RW | Float |
| Gain Mode | RW | Enum (Normal, Bypass) |
| Min Tx Frequency | R | U64 |
| Max Tx Frequency | R | U64 |
| Min Rx Frequency | R | U64 |
| Max Rx Frequency | R | U64 |
| Additional Data | RW | 145 octets (see: TS 25.466 Annex B, |
| | | Table B.3) |

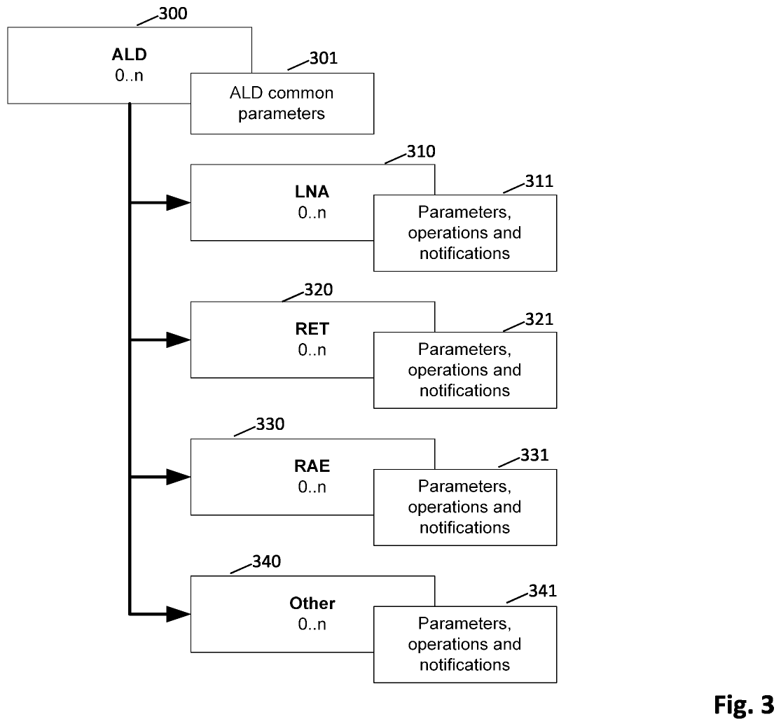

FIG. 3 illustrates a high level model (e.g. abstractive model) for ALDs according to at least some embodiments.

For a plurality of ALDs (e.g. 1 . . . n ALDs) 300 (e.g. corresponding to ALDs 106, 125 of FIG. 1), common ALD parameters 301 are defined, e.g. as listed above.

As AISG 2.0 based examples, each of the ALDs 300 may comprise at least one of an LNA 310, RET 320, RAE 330 and other unit 340. For each of the LNA 310, RET 320, RAE 330 and other unit 340, parameters, operations and notifications 311, 321, 331, 341 may be defined as illustrated in FIG. 3.

However, types of ALDs are not limited to AISG 2.0 based examples, and also cover AISG 3.0 extensions.

It is noted that new types of ALDs can be represented by own branches in the generic model shown in FIG. 3. With this approach, impact of backward compatibility can be minimized.

According to an example embodiment, for ALD software management and ALD configuration file management regular software management procedures between gNB-CU 101/NMS107 and gNB-DU 104/gNB-MU 120 can be utilized.

A use case is about storing configuration data to ALD, for example. In software management, information of what is the content of a particular file (e.g. software, device configuration or device data) may have to be passed. For example, this information cannot be assumed by gNB-DU 104 and gNB-MU 120 and has to be provided in raw form. According to an implementation example, slight modifications of manifest.xml file are considered to handle necessary information.

It is noted that the content of a file being subject of a software management procedure may have to be defined within the procedure, because gNB-DU 104 and gNB-MU 120 may not be able to recognize what the content is, whilst there are different Elementary Procedures needed between Primary and Secondary devices to handle different types of files (e.g. ALD software, ALD configuration file, etc.). According to an example embodiment, the gNB-CU 101/NMS 107 indicates to the gNB-DU 104/gNB-MU 120 the type of content in a specific file being handled with software management procedure.

In other words, according to an example embodiment, the centralized unit (e.g. gNB-CU 101, NMS 107) indicates to the distributed unit (e.g. gNB-DU 104, gMB-MU 120) a type of content in a specific file being handled with a software management procedure for configuration file management of the plurality of antenna line devices.

For example, a device data management use case is about retrieving and storing device data into ALD. According to an implementation example, software management procedures (e.g. with mentioned above extensions regarding the content of file) are used to store device data to ALD. According to an implementation example, for retrieving device data from ALD, RPC “get_device_data_request” plus file management procedures to handle a file created by gNB-DU 104/gNB-MU 120 in result of the RPC processing are used.

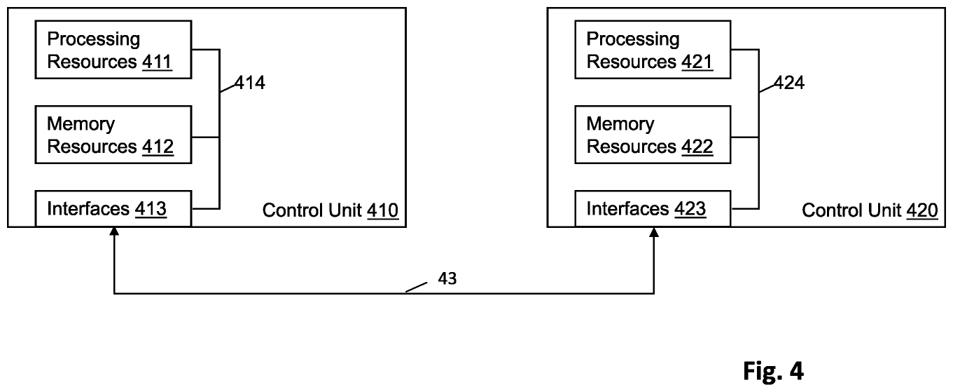

Now reference is made to FIG. 4 illustrating a simplified block diagram of various electronic devices that are suitable for use in practicing the example embodiments and implementation examples.

A control unit 410 comprises processing resources (e.g. processing circuitry) 411, memory resources (e.g. memory circuitry) 412 and interfaces (e.g. interface circuitry) 413 coupled via a connection 414. The control unit 410 is usable by a centralized unit in an HLS network architecture, e.g. the gNB-CU 101 and the NMS 107 of FIG. 1.The control unit 410 is operable to execute process 1 of FIG. 2.

According to an implementation example, the memory resources 412 store a program that includes program instructions that, when executed by the processing resources 411, enable the control unit 410 to operate in accordance with the above described example embodiments.

The control unit 410 is coupled with a control unit 420 via a connection 43. The control unit 420 is usable by a distributed unit in the HLS network architecture, e.g. the gNB-DU 104 and the gNB-MU 120. The connection 43 comprises interfaces 102, 103, 108 and 109 illustrated in FIG. 1.

The control unit 420 comprises processing resources (e.g. processing circuitry) 421, memory resources (e.g. memory circuitry) 422 and interfaces (e.g. interface circuitry) 423 coupled via a connection 424. The control unit 420 is operable to execute process 2 of FIG. 2.

According to an implementation example, the memory resources 422 store a program that includes program instructions that, when executed by the processing resources 421, enable the control unit 420 to operate in accordance with the above described example embodiments.

Further, as used in this application, the term “circuitry” refers to one or more or all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to an aspect, an apparatus for use by a centralized unit of a communication network which adopts a high layer split architecture is provided. The apparatus comprises means for acquiring an abstractive model of a plurality of antenna line devices from a distributed unit of the communication network, wherein the distributed unit performs elementary control of the plurality of antenna line devices, and means for operating the plurality of antenna line devices by communicating with the distributed unit by using the abstractive model.

According to an example implementation, the abstractive model comprises modules according to network configuration protocols.

Alternatively or in addition, the abstractive model comprises modules according to yet another next generation protocol.

Alternatively or in addition, the abstractive model comprises a model comprising at least one of a set of proprietary parameters of each of the plurality of antenna line devices, operation calls and notifications to propagate information about at least one of the plurality of antenna line devices to the centralized unit.

According to an example implementation, the means for operating comprises means for requesting for changes in parameters of at least one of the plurality of antenna line devices. Alternatively or in addition, the means for operating comprises means for requesting operations to be performed by at least one of the plurality of antenna line devices.

According to an example implementation, the apparatus further comprises means for performing an operation to enable high-level data link control between the distributed unit and the plurality of antenna line devices.

According to an example implementation, the means for performing comprises means for transmitting an action trigger to the plurality of antenna line devices.

According to an example implementation, the apparatus further comprises means for acquiring, from the distributed unit, notifications about connected antenna line devices of the plurality of antenna line devices, which comply with high-level data link control, and means for requesting the distributed unit to assign high-level data link control addresses to the connected antenna line devices which comply with high-level data link control.

According to an example implementation, the means for requesting uses unique identifiers each formed of at least two parts, and each identifying a connected antenna line device of the connected antenna line devices.

According to an example implementation, the means for operating the plurality of antenna line devices by communicating with the distributed unit by using the abstractive model uses the unique identifiers.

According to an example implementation, the apparatus further comprises means for indicating to the distributed unit a type of content in a specific file being handled with a software management procedure for configuration file management of the plurality of antenna line devices.

According to an example implementation, the apparatus comprises and/or uses the control unit 410 of FIG. 4.

According to an aspect, an apparatus for use by a distributed unit of a communication network which adopts a high layer split architecture is provided. The apparatus comprises means for providing an abstractive model of a plurality of antenna line devices to a centralized unit of the communication network, means for performing communication with the centralized unit by using the abstractive model regarding operation of the plurality of antenna line devices, and means for performing elementary control of the plurality of antenna line devices.

According to an example implementation, the means for performing elementary control performs the elementary control of the plurality of antenna line devices based on the communication with the centralized unit.

According to an example implementation, the elementary control comprises a set of elementary procedures and functions related to protocol layer termination according to at least one of high-level data link control (HDLC) and antenna interface standards group (AISG).

According to an example implementation, the means for performing the elementary control comprising means for scanning connected antenna line devices of the plurality of antenna line devices, which comply with high-level data link control.

Alternatively or in addition, the means for performing the elementary control comprising means for detecting antenna line devices of the plurality of antenna line devices, which comply with high-level data link control device detection.

Alternatively or in addition, the means for performing the elementary control comprising means for assigning high-level data link control addresses to connected antenna line devices which comply with high-level data link control.

Alternatively or in addition, the means for performing the elementary control comprising means for polling towards antenna line devices of the plurality of antenna line devices, which have been assigned high-level data link control addresses.

Alternatively or in addition, the means for performing the elementary control comprising means for communicating with antenna line devices of the plurality of antenna line devices, which have been assigned high-level data link control addresses, with respect to at least one of timing constraints, alarm reporting and configuration of the antenna line devices.

According to an example implementation, when performing the elementary control, the apparatus represents a primary device and the plurality of antenna line devices represent secondary devices.

According to an example implementation, the apparatus further comprises means for providing the centralized unit with notifications about connected antenna line devices of the plurality of antenna line devices, which comply with high-level data link control.

According to an example implementation, the apparatus further comprises means for receiving, from the centralized unit, a request to assign a high-level data link control address to a connected antenna line device of the connected antenna line devices, the request comprising a unique identifier identifying the connected antenna line device.

According to an example implementation, the apparatus further comprises means for acquiring, from the centralized unit, a type of content in a specific file being handled with a software management procedure for configuration file management of the plurality of antenna line devices.

According to an example implementation, the means for performing the elementary control performs the elementary control of the plurality of antenna line devices via at least one radio unit.

According to an example implementation, the abstractive model comprises modules according to network configuration protocols.

Alternatively or in addition, the abstractive model comprises modules according to yet another next generation protocol.

Alternatively or in addition, the abstractive model comprises a model comprising at least one of a set of proprietary parameters of each of the plurality of antenna line devices, operation calls and notifications to propagate information about at least one of the plurality of antenna line devices to the centralized unit.

According to an example implementation, the apparatus comprises the control unit 420 of FIG. 4.

It is to be understood that the above description is illustrative and is not to be construed as limiting the disclosure. Various modifications and applications may occur to those skilled in the art without departing from the true spirit and scope as defined by the appended claims.

1. A centralized unit for use in a communication network which adopts a high layer split architecture, the centralized unit using at least one processor and at least one non-transitory memory including computer program code, the at least one memory and the computer program code configured to, with the at least one processor, cause the centralized unit at least to perform:
acquiring an abstractive model of a plurality of antenna line devices from a distributed unit of the communication network, wherein the distributed unit performs elementary control of the plurality of antenna line devices; and
operating the plurality of antenna line devices by communicating with the distributed unit by using the abstractive model.

2. The centralized unit of claim 1, the operating comprising at least one of:
requesting for changes in parameters of at least one of the plurality of antenna line devices; or
requesting operations to be performed by at least one of the plurality of antenna line devices.

3. The centralized unit of claim 1, wherein the abstractive model comprises at least one of the following:
modules according to network configuration protocols,
modules according to yet another next generation protocol, or
a model comprising at least one of:
a set of proprietary parameters of each of the plurality of antenna line devices,
operation calls and notifications to propagate information about at least one of the plurality of antenna line devices to the centralized unit.

4. The centralized unit of claim 1, wherein the at least one memory and the computer program code are configured to, with the at least one processor, cause the centralized unit to further perform:
performing an operation to enable high-level data link control between the distributed unit and the plurality of antenna line devices.

5. The centralized unit of claim 4, the performing comprising:
transmitting an action trigger to the plurality of antenna line devices.

6. The centralized unit of claim 1, wherein the at least one memory and the computer program code are configured to, with the at least one processor, cause the centralized unit to further perform:
acquiring, from the distributed unit, notifications about connected antenna line devices of the plurality of antenna line devices, which comply with high-level data link control; and
requesting the distributed unit to assign high-level data link control addresses to the connected antenna line devices which comply with high-level data link control.

7. The centralized unit of claim 6, wherein the requesting is based on unique identifiers each formed of at least two parts, and each identifying a connected antenna line device of the connected antenna line devices.

8. The centralized unit of claim 6, the operating the plurality of antenna line devices by communicating with the distributed unit by using the abstractive model comprising:
using the unique identifiers.

9. The centralized unit of claim 1, wherein the at least one memory and the computer program code are configured to, with the at least one processor, cause the centralized unit to further perform:
indicating to the distributed unit a type of content in a specific file being handled with a software management procedure for configuration file management of the plurality of antenna line devices.

10. The centralized unit of claim 1, wherein the centralized unit comprises at least one of a high layer split centralized unit or a network management system.

11. A distributed unit for use in a communication network which adopts a high layer split architecture, the distributed unit using at least one processor and at least one non-transitory memory including computer program code, the at least one memory and the computer program code configured to, with the at least one processor, cause the distributed unit at least to perform:
providing an abstractive model of a plurality of antenna line devices to a centralized unit of the communication network;
performing communication with the centralized unit by using the abstractive model regarding operation of the plurality of antenna line devices; and
performing elementary control of the plurality of antenna line devices.

12. The distributed unit of claim 11, the performing elementary control comprising:
performing the elementary control of the plurality of antenna line devices based on the communication with the centralized unit.

13. The distributed unit of claim 11, wherein the elementary control comprises a set of elementary procedures and functions related to protocol layer termination according to at least one of:
high-level data link control, or
antenna interface standards group.

14. The distributed unit of claim 11, the performing of the elementary control comprising at least one of the following:
scanning connected antenna line devices of the plurality of antenna line devices, which comply with high-level data link control;
detecting antenna line devices of the plurality of antenna line devices, which comply with high-level data link control device detection;
assigning high-level data link control addresses to connected antenna line devices which comply with high-level data link control;
polling towards antenna line devices of the plurality of antenna line devices, which have been assigned high-level data link control addresses; or
communicating with antenna line devices of the plurality of antenna line devices, which have been assigned high-level data link control addresses, with respect to at least one of timing constraints, alarm reporting or configuration of the antenna line devices.

15. The distributed unit of claim 11, wherein, when performing the elementary control, the distributed unit represents a primary device and the plurality of antenna line devices represent secondary devices.

16. The distributed unit of claim 11, wherein the abstractive model comprises at least one of the following:
modules according to network configuration protocols,
modules according to yet another next generation protocol, or
a model comprising at least one of:
a set of proprietary parameters of each of the plurality of antenna line devices,
operation calls or
notifications to propagate information about at least one of the plurality of antenna line devices to the centralized unit.

17. The distributed unit of claim 11, wherein the at least one memory and the computer program code are configured to, with the at least one processor, cause the distributed unit to further perform:
providing the centralized unit with notifications about connected antenna line devices of the plurality of antenna line devices, which comply with high-level data link control.

18. The distributed unit of claim 17, wherein the at least one memory and the computer program code are configured to, with the at least one processor, cause the distributed unit to further perform:
receiving, from the centralized unit, a request to assign a high-level data link control address to a connected antenna line device of the connected antenna line devices, the request comprising a unique identifier identifying the connected antenna line device.

19. The distributed unit of claim 11, wherein the at least one memory and the computer program code are configured to, with the at least one processor, cause the distributed unit to further perform:
acquiring, from the centralized unit, a type of content in a specific file being handled with a software management procedure for configuration file management of the plurality of antenna line devices.

20. The distributed unit of claim 11, wherein the distributed unit comprises at least one of a high layer split distributed unit or a high layer split middle unit.

21. The distributed unit of claim 11, the performing of the elementary control comprising:
performing the elementary control of the plurality of antenna line devices via at least one radio unit.

22. A method for use by a centralized unit of a communication network which adopts a high layer split architecture, the method comprising:
acquiring an abstractive model of a plurality of antenna line devices from a distributed unit of the communication network, wherein the distributed unit performs elementary control of the plurality of antenna line devices; and
operating the plurality of antenna line devices by communicating with the distributed unit by using the abstractive model.

23-29. (canceled)

30. A method for use by a distributed unit of a communication network which adopts a high layer split architecture, the method comprising:
providing an abstractive model of a plurality of antenna line devices to a centralized unit of the communication network;
performing communication with the centralized unit by using the abstractive model regarding operation of the plurality of antenna line devices; and
performing elementary control of the plurality of antenna line devices.

31-39. (canceled)

40. A non-transitory computer-readable storage medium storing a program that causes a computer to execute the method of claim 22, when the program is run on the computer.

41. A non-transitory computer-readable storage medium storing a program that causes a computer to execute the method of claim 30, when the program is run on the computer.
